(19) United States
(12) Patent Application Publication
(10) Pub. No.: US 2010/0218648 A1
(43) Pub. Date: Sep. 2, 2010

(54) LOCKING PLIERS WITH ONE-HAND ADJUSTMENT

(75) Inventors: Thomas M. Chervenak, Stanley, NC (US); David P. Engvall, Stanley, NC (US)

Correspondence Address: MOORE & VAN ALLEN PLLC, P.O. BOX 13706, Research Triangle Park, NC, 27709, US

(73) Assignee: IRWIN INDUSTRIAL TOOL COMPANY, Huntersville, NC (US)

(21) Appl. No.: 12/396,083

(22) Filed: Mar. 2, 2009

(51) Int. Cl. B25B 7/14

(52) U.S. Cl. 81/326

(57) ABSTRACT

A locking pliers comprises a fixed assembly comprising a first handle and a first jaw. A second jaw is movable relative to the first jaw. A second handle moves relative to the first handle to move the second jaw. A toggle-link locking mechanism locks the second jaw in the closed, locked position. An adjusting screw is provided for adjusting the geometry of the locking mechanism to thereby adjust the jaw spacing and the force exerted by the jaws is provided. The adjusting screw includes a wheel that can be rotated by running the wheel along an object. In another embodiment the adjusting screw includes a sleeve that extends partially over the fixed assembly such that it can be manipulated by the same hand that holds the locking pliers.

This invention relates generally to locking pliers and, more particularly, to a locking pliers that can be adjusted with one hand.

### BACKGROUND

Pliers-type hand tools with toggle-locking mechanisms are generally known as locking pliers. These pliers usually comprise a fixed handle having a fixed jaw on one end thereof. A movable handle pivots a movable jaw relative to the fixed handle to open and close the jaws. To grip a workpiece the handles are tightly compressed such that the linkage of the toggle-locking mechanism locks the pliers onto the workpiece. Adjustments in the jaw opening and the force applied by the jaws to the workpiece are generally made by turning an adjusting screw mounted in the fixed handle that engages the toggle locking mechanism. Typically the pliers are held in one hand and the adjusting screw is rotated using the other hand. The adjusting screw is translated relative to the fixed handle to modify the physical dimensions of the toggle mechanism to vary the effective length of the linkage of the toggle-locking mechanism. This adjustment varies the distance between the ends of the toggle linkage to vary the force applied by the jaws to the workpiece when the tool is locked. The pliers will remain firmly locked in place without the continuous application of force by the user.

### SUMMARY OF THE INVENTION

A locking pliers comprises a fixed assembly comprising a first handle supporting a first jaw. A second jaw is movable relative to the first jaw between an open position and a closed, locked position. A second handle moves relative to the first handle to move the second jaw between open and closed positions. A toggle-link locking mechanism locks the second jaw in the closed, locked position. An adjusting screw is provided for adjusting the geometry of the locking mechanism to thereby adjust the jaw spacing and the force exerted by the jaws is provided. This adjustment varies the distance between the ends of the toggle linkage to vary the force applied by the jaws to the workpiece when the tool is locked. The adjusting screw includes a wheel that can be rotated by running the wheel along an object. In another embodiment the adjusting screw includes a sleeve that extends partially over the fixed assembly such that it can be manipulated by the same hand that holds the locking pliers.

### BRIEF DESCRIPTION OF THE DRAWINGS

FIG. 1 is a side view of one embodiment of a locking pliers according to the present invention.

FIGS. 2 through 4 are views of the adjustment wheel of the invention illustrating the methodology for determining the proper size of the wheel.

FIG. 5 is a side view of another embodiment of a locking pliers according to the present invention.

FIG. 6 is a side view of another embodiment of a locking pliers according to the present invention.

FIGS. 7 and 8 are side views of alternate embodiments of the adjustment wheel of the invention.

FIG. 9 is an end view of another alternate embodiment of the adjustment wheel of the invention.

### DETAILED DESCRIPTION OF EMBODIMENTS OF THE INVENTION

Pliers 1 include a fixed assembly 10 having a fixed handle 12 at one end and a fixed jaw 13 at the other end. A movable handle 19 is pivotably connected at one end to a movable jaw 16 by pivot pin 20. A pivot pin 18 connects the movable jaw 16 to the fixed assembly 10. The fixed assembly 10 receives the pivot pin 18.

A toggle locking mechanism 27 locks the movable jaw 16 relative to the fixed jaw 13. A link 22 is pivotably connected to the movable handle 19 by a pivot pin 26. The opposite end 32 of link 22 is in sliding and pivoting contact with the end 14a of adjustment screw 14. A projection 33 extends transversely to the length direction of the link 22 and acts as a stop when the jaws are in the closed position. The projection 33 may contact with the handle 19 directly. Alternatively a release lever 40 may be provided where one end of the lever 40a is disposed between the lever and the handle 19. The lever 40 is pivoted to the movable handle 19 at pin 42 such that a user can depress the distal end of lever 40 to lift end 40a and unlock the linkage 27. A biasing spring 29 extends between an opening 30 on the movable jaw 16 to a tab 31 protruding from fixed handle 12. The spring 29 applies a bias which tends to move the jaws 13 and 16 away from one another.

When the jaws 13 and 16 are in the open position, the pivot points, 18, 20, 26 and the point of contact between the end 32 of link 22 with the end of the adjusting screw 14 are arranged as a polygon. When the jaws are in the closed position, the pivots 20, 26 and the point of contact between link 22 and screw 14 are substantially in a straight line with the pin 26 in an over-center position where it is positioned slightly inside (toward fixed assembly 10) of the line between pivot 20 and the point of contact between link 22 and the screw 14. The jaws 13 and 16 cannot be pried apart from the locked position by use of force which pulls or pushes on the jaws 13 and 16 because separation of the jaws is prevented by the over-center condition of the pin 26. However, the jaws 13 and 16 may be separated by applying a force to the movable handle 19 in a direction which moves the movable handle 19 away from the fixed handle 12. A configuration of the pivots which places the mechanism in a locked position when the jaws are closed or grasping a workpiece can be considered an over-center mechanism when force applied directly to the jaws is not effective in separating the jaws. The jaws can only be opened by forces acting on the links of the mechanism. Other locking mechanisms are known and may also be used to lock the handles relative to one another. For example, the locking mechanism may include a compound linkage for effecting the locking function.

The end of the fixed handle 12, remote from the jaw 13, is completed with a threaded circular aperture 15 through which threaded adjustment screw 14 is threadably engaged. The end 32 of the link 22 is slidably and pivotably engaged with the end of the adjusting screw 14. As is apparent from the drawing, turning the adjusting screw 14 changes the distance between the end 32 of the link 22 and the pivot point 18 of the movable jaw 16 to change the geometry of the linkage, whereby the jaws may be adjusted to grip objects of different dimensions with varying force.

The adjusting screw 14 includes a wheel 50 is connected to the distal end of the adjusting screw that is used to rotate the screw to make the adjustment. The wheel 50 may either be a separate component that is fixed to the adjusting screw or the wheel 50 may be formed as one piece with the adjusting screw. The wheel 50 is sized such that it can be rotated by the friction of running the wheel along an object. In this embodiment the adjusting screw includes a large diameter wheel that allows the user to run the wheel over, for example, the user's leg to adjust the pliers. This allows the user to adjust the pliers using only one hand leaving the user's other hand free. The ability of the pliers to be adjusted by running the wheel over a surface is based on the geometry of the wheel as it relates to the mechanics of the pliers. In addition to increasing the diameter of the wheel, the wheel may be provided with an increased thickness t such that sufficient surface area is provided to engage the surface with which the wheel is engaged. Further, the wheel may be provided with a knurled peripheral outer surface 50a to increase the frictional engagement of the wheel with the surface.

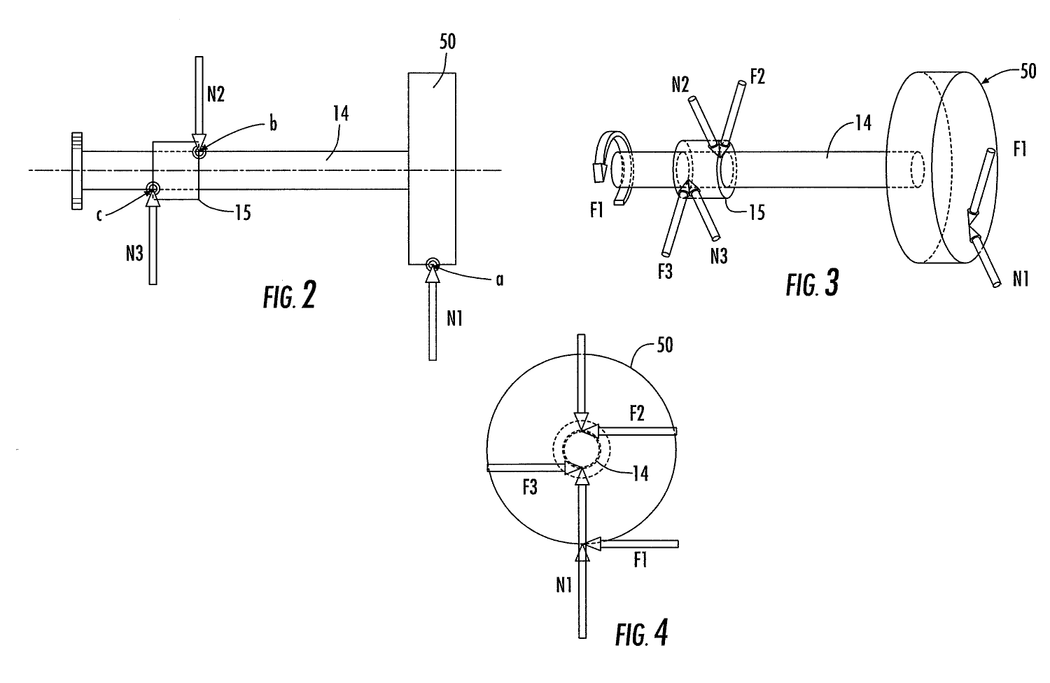

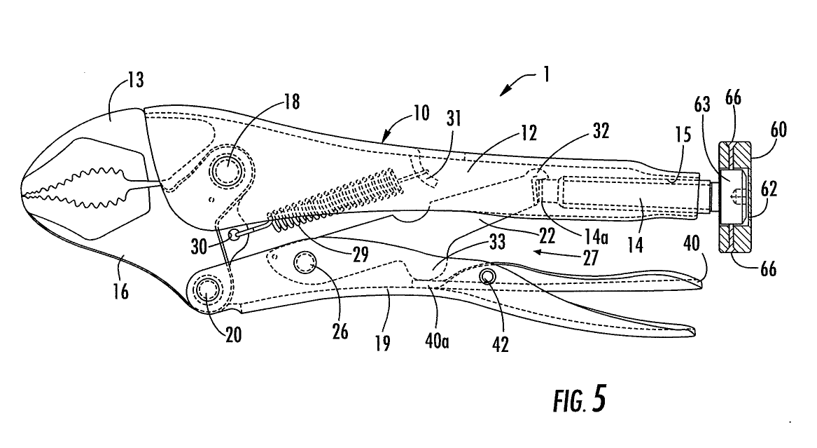

The radius of the wheel is based on the mechanics of the locking pliers. The radius depends on the size of the locking pliers where a larger locking pliers requires a larger diameter wheel. Reference is made to FIGS. 2 through 4 to explain the appropriate wheel dimension. In these figures:
N1 is the normal force on the wheel 50;
N2 is the normal force on the screw 14 at the end of the nut nearest to the wheel 50 (the “nut” means the threaded portion of the pliers into which the adjustment screw is threaded);
N3 is the normal force on the screw 14 at the end of the nut farthest from the wheel 50;
F1 is the maximum friction force on the wheel 50;
F2 is the maximum friction force on the screw 14 at the end of the nut nearest the wheel 50;
F3 is the maximum friction force on the screw 14 at the end of the nut furthest from the wheel 50;
T1 is the torque due to friction on the screw 14;
A is the length of the screw 14;
B is the length of the nut;
Alpha W is the coefficient of friction of the wheel 50 in contact with the adjusting surface;
Alpha S is the coefficient of friction of the screw 14 on the nut;
S is the radius of the screw 14;
W is the radius of the wheel.

Summing moments about point b: N1(A)=N3(B)→N3=N1(A)/B

Summing vertical forces: N1+N3=N2

Therefore, N2=N1+N1(A/B)

F1=N1(Alpha W)→N1=F1/Alpha W

F2=N2(Alpha S)→N2=F2/Alpha S

F3=N3(Alpha S)→substituting for N3 from equation (1)→N1(A)/B×(Alpha S)

Solving for W:

T1+F2S+F3S=F1W

T1+N2(Alpha S)S+N1A/B(Alpha S)S=N1(Alpha W)W

T1+(N1+N1A/B)S(Alpha S)+N1A/B(Alpha S)S=N1(Alpha W)W

T1+N1S(Alpha S)+N1S(Alpha S)A/B+N1S(Alpha S)A/B=N1W(Alpha W)

T1+N1S(Alpha S+2 Alpha S A/B)=N1W(Alpha W)

T1/N1(Alpha W)+N1S(Alpha S+2 AlphaS A/B)/N1(Alpha W)=W

T1/N1(Alpha W)+SAlpha S/Alpha W+2SA/B AlphaS/Alpha W=W

T1/N1(Alpha W)+SAlpha S/Alpha W(1+A/B)=W

For a ten inch locking pliers, the desired minimum size of the wheel is a one inch diameter. If the wheel has a diameter much greater than 1.5 inches it has been found that, while the wheel can adjust the locking pliers, the profile of the wheel becomes somewhat unwieldy and may interfere with the use of the pliers. A wheel having a diameter of 1.5 inches has been found to work well for most sized locking pliers. Thus, a diameter of between approximately ⅞ inch and approximately 1.5 inches is most preferred for most locking pliers.

To achieve the benefits of the one-hand operation of the invention, the wheel 50 has a width t suitable to allow the wheel 50 to be pressed against a surface and rotate the screw 14. While the width t of the wheel 50 theoretically does not affect the ability of the wheel to rotate the adjustment screw 14, the wheel 50 should have a width sufficient to provide sufficient traction between the wheel 50 and the surface against which the wheel is pressed. Moreover, the width of wheel 50 should be sufficient to be comfortable when pressed against the user's body.

The wheel 50 can be formed as an integral part of the screw where the wheel and screw form part of the pliers as manufactured and sold. The wheel and adjusting screw may be one piece. Further, the screw 14 with the large wheel 50 of the invention can be sold separately as a replacement part for existing pliers. The existing screw can be removed from the handle 12 by unscrewing the screw from the threaded aperture 15. The replacement screw 14 with the large wheel 50 of the invention can then be screwed into the threaded aperture 15. Further, as shown in FIG. 5 the wheel 60 can be formed as a separate component that is attached to the existing screw of a locking pliers. The wheel 60 includes a socket 62 that receives the head 63 of the existing screw 14. A set screw or a plurality of set screws 66 can be used to fix the wheel to the head of the screw. Other attachment mechanisms may also be used such as adhesive, a press fit, friction fit or the like.

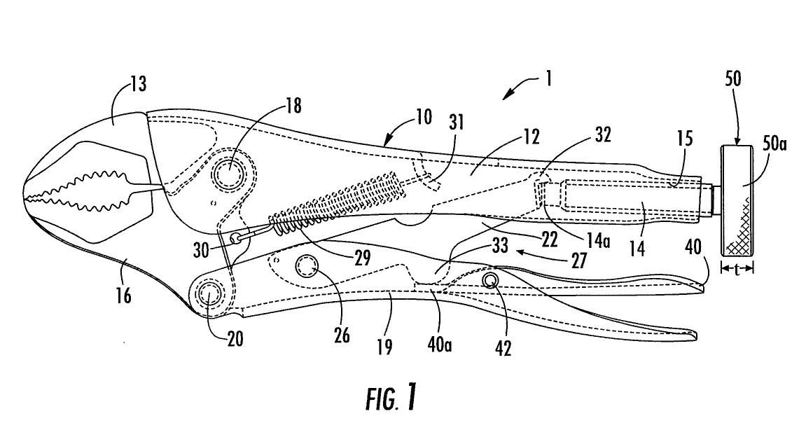

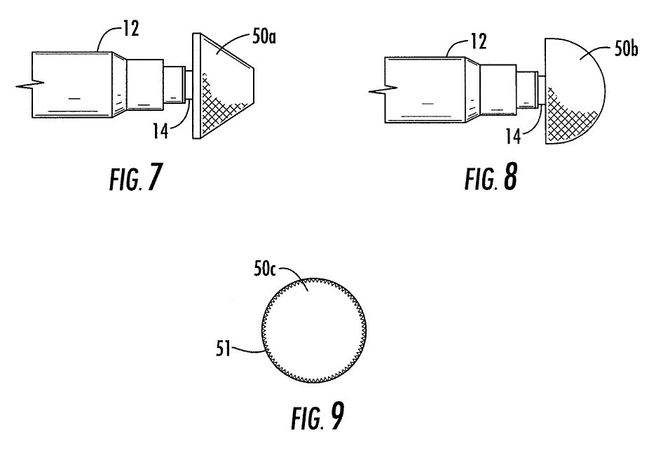

The wheel may also be formed as a truncated cone as shown in FIG. 7 rather than as a cylinder as shown in FIGS. 1 through 6. By making the wheel 50a a truncated cone the pliers can be held at an angle relative to the surface against which the wheel is pressed and rotated. Such an orientation may be more comfortable for the user in some uses. Further the wheel may also have a spherical or semi-spherical shape as shown at wheel 50b in FIG. 8. The rounded portion of the wheel may be a round sphere or an oval sphere. Referring to FIG. 9, the peripheral outer surface of the wheel 5 0c may also be formed with gear teeth 51 to increase the traction of the wheel with the surface. The wheel may have other shapes that allow the wheel to rotate when pressed against and rolled over a surface.

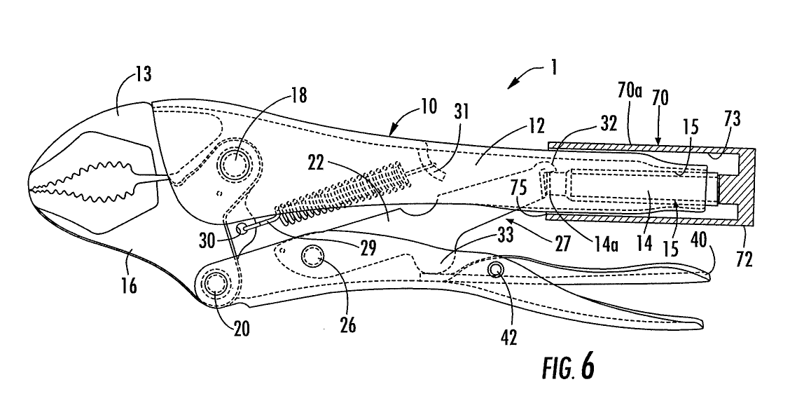

Another embodiment of the invention is shown in FIG. 6. In the embodiment of FIG. 6 like reference numerals are used to identify like components previously described with respect to the embodiment of FIGS. 1 through 4. An adjustment sleeve 70 is provided for rotating the adjustment screw 14. Sleeve 70 comprises a member having a first end 72 that is connected to the exposed end of the adjustment screw 14. The sleeve may be a separate component that is fixed to the adjusting screw or the sleeve and adjusting screw may be made in one piece. The sleeve has a second end 75 that defines an interior cavity 73 for receiving handle 12. The sleeve 70 extends over the fixed handle 12 such that the handle extends into the cavity 73. The sleeve 70 extends for a portion of the handle 12 such that it can be manipulated by the same hand that grips the pliers. The sleeve 70 may be provided with a cylindrical outer surface 70a.

Specific embodiments of an invention are disclosed herein. One of ordinary skill in the art will recognize that the invention has other applications in other environments. Many embodiments are possible. The following claims are in no way intended to limit the scope of the invention to the specific embodiments described above.

1. A lockable pliers comprising:
a fixed assembly comprising a first handle supporting a first jaw;
a second jaw movable relative to the first jaw between an open position and a closed, locked position;
a second handle movable relative to the first handle;
a locking mechanism for locking the second jaw in the closed, locked position;
a screw for adjusting the geometry of the locking mechanism; and
a wheel for rotating the adjustment screw, the wheel having a diameter sufficient to allow the screw to be rotated by riding the wheel over a surface.

2. The locking pliers of claim 1 wherein said wheel has a diameter of at least ⅞ inch.

3. The locking pliers of claim 1 wherein said wheel has a diameter of between ⅞ inch and 1.5 inches.

4. The locking pliers of claim 2 wherein the radius of the wheel is determined by the equation T1/N1(Alpha W)+SAlpha S/Alpha W(1+A/B).

5. A locking pliers comprising:
a fixed assembly comprising a first handle supporting a first jaw;
a second jaw movable relative to the first jaw between an open position and a closed, locked position;
a second handle movable relative to the first handle;
a locking mechanism for locking the second jaw in the closed, locked position;
a screw for adjusting the geometry of the locking mechanism; and
a sleeve connected to said screw and extending over said first handle.

6. The locking pliers of claim 5 wherein said sleeve includes a cavity, said cavity receiving said first handle.

7. The locking pliers of claim 5 wherein said sleeve has a cylindrical outer surface.

8. A method of gripping a workpiece with a locking pliers comprising:
providing a fixed assembly comprising a first handle supporting a first jaw;
providing a second jaw movable relative to the first jaw between an open position and a closed, locked position;
providing a second handle movable relative to the first handle, said second handle connected to the second jaw at a fixed pivot;
gripping at least the first handle by a hand;
providing a locking mechanism for locking the second jaw in the closed, locked position comprising a screw for adjusting the geometry of the locking mechanism, and a wheel for rotating the screw;
rotating the wheel against an object while gripping said pliers in said hand.
